(19) United States
(12) Patent Application Publication
(10) Pub. No.: US 2026/0225299 A1
(43) Pub. Date: Aug. 6, 2026

(54) MOLDING MANAGEMENT SYSTEM

(71) Applicant: SEIKO EPSON CORPORATION, Tokyo (JP)

(72) Inventors: Tomoya OTA, MATSUMOTO-SHI (JP); Yuji SAITO, MATSUMOTO-SHI (JP); Junta TAKAYAMA, YAMAGATA-MURA (JP)

(73) Assignee: SEIKO EPSON CORPORATION, Tokyo (JP)

(21) Appl. No.: 19/461,741

(22) Filed: Jan. 28, 2026

(30) Foreign Application Priority Data
Jan. 31, 2025 (JP) 2025-014763

(51) Int. Cl. B29C 45/76

(52) U.S. Cl. CPC B29C 45/76; B29C 2045/7606

(57) ABSTRACT

A molding management system for managing production of a product in a production process including an injection molding process of the product performed by an injection molding apparatus, includes an information processing device communicably connected to a terminal device, and the information processing device includes a storage unit configured to store one or more pieces of data acquired from the injection molding apparatus, and a control unit configured to classify, based on a first classification condition designated by a first operation that is received, the data into a plurality of types of first post-classification data and display, on a display unit, a graph indicating a data amount of each of the plurality of types of first post-classification data that are classified.

The present application is based on, and claims priority from JP Application Serial Number 2025-014763, filed Jan. 31, 2025, the disclosure of which is hereby incorporated by reference herein in its entirety.

### BACKGROUND

### Technical Field

The present disclosure relates to a molding management system.

### Related Art

A technique for managing production of a product in a production process including an injection molding process of the product performed by an injection molding apparatus has been studied and developed.

Here, there is known a technique capable of visualizing and displaying an operation state of an injection molding apparatus, the presence or absence of occurrence of an abnormality, and the like by a graph based on data acquired from the injection molding apparatus (see JP-A-2013-086434).

JP-A-2013-086434 is an example of the related art.

Here, in the technique described in JP-A-2013-086434, it may be difficult to specify a data amount of each breakdown of the data acquired from the injection molding apparatus. This may increase time and effort required for a system administrator or the like to manage the data, which is not desirable.

### SUMMARY

In order to solve the above problem, an aspect of the present disclosure is a molding management system for managing production of a product in a production process including an injection molding process of the product performed by an injection molding apparatus, the molding management system including an information processing device communicably connected to a terminal device, in which the information processing device includes a storage unit configured to store one or more pieces of data acquired from the injection molding apparatus, and a control unit configured to classify, based on a first classification condition designated by a first operation that is received, the data into a plurality of types of first post-classification data and display, on a display unit, a graph indicating a data amount of each of the plurality of types of first post-classification data that are classified.

### BRIEF DESCRIPTION OF THE DRAWINGS

FIG. 1 is a diagram showing an example of a configuration of a molding management system 1.

FIG. 2 is a diagram showing a first example of a data amount display image P1.

FIG. 3 is a diagram showing an example of the data amount display image P1 including a second classification condition information reception image F1.

FIG. 4 is a diagram showing an example of the data amount display image P1 immediately after a second classification condition is changed.

FIG. 5 is a diagram showing another example of the data amount display image P1 immediately after the second classification condition is changed.

FIG. 6 is a diagram showing an example of a graph indicating, by percentage, a data amount of first post-classification data when a first classification condition is to distinguish by each acquisition date and time and the second classification condition is to distinguish by each injection molding apparatus serving as an acquisition source.

FIG. 7 is a diagram showing an example of a pie chart showing the data amount of the first post-classification data when the first classification condition is to distinguish by each injection molding apparatus serving as the acquisition source.

FIG. 8 is a diagram showing an example of a calendar heat map indicating the data amount of the first post-classification data when the first classification condition is to distinguish by each acquisition date and time.

FIG. 9 is a diagram showing an example of a state of the data amount display image P1 immediately after an operation of selecting a region corresponding to a part of the first post-classification data displayed in a graph G2 shown in FIG. 5.

FIG. 10 is a diagram showing an example of a hardware configuration of an information processing device X.

FIG. 11 is a diagram showing an example of a functional configuration of the information processing device X.

FIG. 12 is a diagram showing an example of a flow of processes performed by the information processing device X in response to a received operation.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. The information processing device is communicably connected to a terminal device. The information processing device includes a storage unit and a control unit. The storage unit stores one or more pieces of data acquired from the injection molding apparatus. The control unit classifies the data based on a first classification condition designated by a first operation that is received, and displays, on a display unit, a graph indicating a data amount of each piece of the classified data. Accordingly, the molding management system can display, on the display unit, the data amount of each piece of the data classified according to a desired classification condition. This means that a data amount of each breakdown of the data can be displayed. As a result, the molding management system can reduce the time and effort required for a system administrator or the like to manage the data.

In the following description, a configuration of the molding management system according to such an embodiment and processing performed by a server provided in the molding management system will be described in detail. In the present embodiment, when a certain piece of information X1 and another piece of information X2 are different information, a type of the information X1 is treated as different from a type of the information X2. That is, in the present embodiment, a certain piece of data including a plurality of pieces of different information means the data including a plurality of types of information. Further, in the present embodiment, when it is necessary to distinguish a display mode in each region in the drawing, a color of the region is represented by hatching of each region. Examples of the display mode include, but are not limited to, a type of the color and a shade of the color.

### Configuration of Molding Management System

Hereinafter, the configuration of the molding management system according to the embodiment will be described by taking a molding management system 1 as an example.

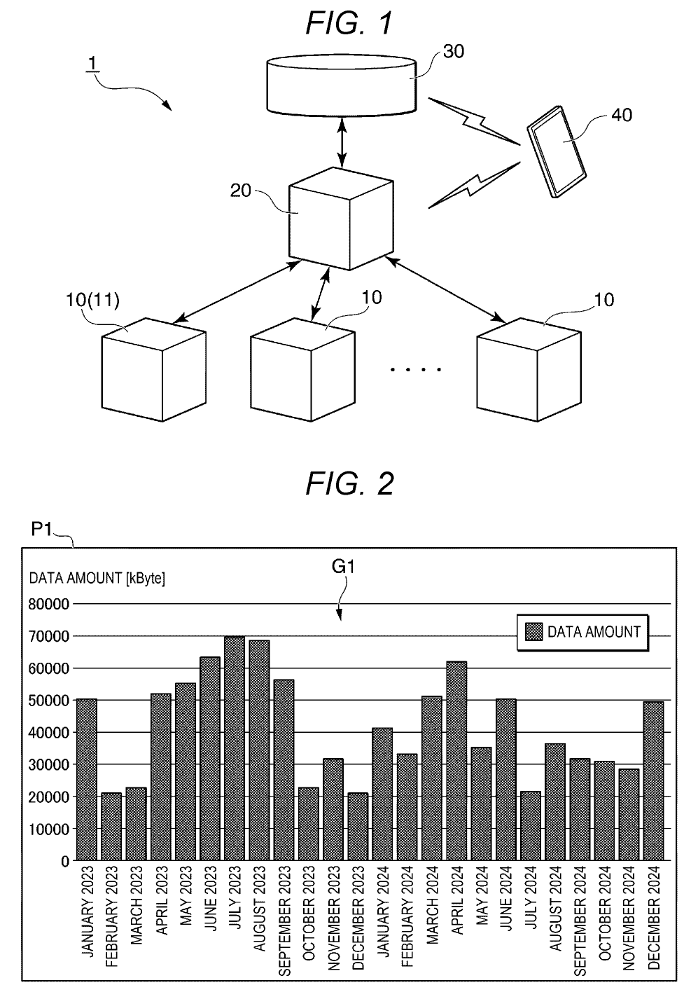

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. Further, the molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The conveying device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding process of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a process in which the injection molding apparatus performs injection molding of a product once is referred to as a cycle. Hereinafter, for convenience of description, a cavity in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes a material used for injection molding of a product into the cavity in the mold attached to the injection molding apparatus in the injection molding process. The extrusion unit is, for example, a screw that moves a position in a cylinder back and forth by rotating in the cylinder. Instead of the screw, the extrusion unit may be a member that moves the position in the cylinder back and forth by a hydraulic pressure, a linear actuator, or the like. The material is extruded from an injection port of the cylinder toward the cavity in the mold in response to advance of the extrusion unit in the cylinder. Hereinafter, for convenience of description, the extrusion unit in the injection molding apparatus is referred to as a screw.

Further, M detection units are attached to each of the one or more injection molding apparatuses in the plurality of managed devices 10. M may be any integer equal to or greater than 2. The M detection units detect a quantity controlled by the injection molding apparatus in each cycle. The quantity controlled by the injection molding apparatus in each cycle is, for example, a part or all of a position of the screw, a rotation speed of the screw, an injection speed, an injection holding pressure, a cycle time, a measurement time, an apparatus temperature, a mold temperature, and a filling time, but is not limited thereto. Hereinafter, for convenience of description, the quantity detected by each of the M detection units attached to each of the one or more injection molding apparatuses in the plurality of managed devices 10 is simply referred to as a detection quantity. The injection speed is a speed at which the injection molding apparatus injects the material into the cavity in the mold by the screw. The injection holding pressure is a pressure in the mold held by the screw. The cycle time is a time required to execute one cycle. The measurement time is a time required for measurement in the cycle. The apparatus temperature is a temperature of the injection molding apparatus. The mold temperature is a temperature in the mold. The filling time is a time required to fill the cavity of the mold with the material. Here, a detection unit that detects a certain detection quantity among the M detection units attached to a certain injection molding apparatus is, for example, a sensor that detects the detection quantity, but is not limited thereto. The M detection units may include a detection unit that detects a quality of the product. This is because the quality of the product is also controlled by the injection molding apparatus in each cycle. In this case, the detection unit is, for example, a device that includes an imaging unit capable of imaging the product to detect the quality of the product, but is not limited thereto. In this case, for example, a value of the detection quantity indicating the quality of the product detected by the detection unit is, for example, any of a plurality of predetermined values arranged in descending order of quality, but is not limited thereto.

The information processing device 20 acquires various types of data such as cycle data, injection molding condition data, and operation state history data from each of the one or more injection molding apparatuses in the plurality of managed devices 10. Hereinafter, in order to simplify the description, as an example, a case in which two types of data, including the cycle data and the injection molding condition data, are acquired by the information processing device 20 from each of the one or more injection molding apparatuses will be described. The information processing device 20 independently acquires each of the two types of data. Therefore, in this example, timings at which these two types of data are acquired by the information processing device 20 are different from each other, except for a case in which the timings accidentally match each other, unless the timings are intentionally matched.

The information processing device 20 acquires the cycle data for each cycle from each of the one or more injection molding apparatuses in the plurality of managed devices 10. More specifically, the information processing device 20 acquires the cycle data from each of the one or more injection molding apparatuses every time each cycle ends. Hereinafter, for convenience of description, the cycle data acquired when a certain cycle ends is referred to as cycle data of the cycle. Hereinafter, for convenience of description, a cycle that ends when certain cycle data is acquired is referred to as a cycle of the cycle data.

The cycle data acquired from a certain injection molding apparatus in a certain cycle includes a plurality of types of information. Specifically, the cycle data includes a plurality of pieces of cycle-related information obtained in response to execution of the cycle by the injection molding apparatus, apparatus identification information for identifying the injection molding apparatus, and first date-and-time information indicating an acquisition date and time when the cycle data is acquired by the information processing device 20 from the injection molding apparatus. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the acquisition date and time. The cycle data may include other information in addition to the plurality of pieces of cycle-related information, the apparatus identification information, and the first date-and-time information. A part of the plurality of types of information included in the cycle data may be included in the cycle data as metadata. A data amount of the cycle data may be calculated based on a data amount of each of the plurality of types of information included in the cycle data, or may be specified by data amount information indicating a data amount included in the cycle data. The apparatus identification information may be included in the cycle data as any piece of the plurality of pieces of cycle-related information. Hereinafter, as an example, a case in which the apparatus identification information is included in the cycle data as any piece of the plurality of pieces of cycle-related information will be described.

The plurality of pieces of cycle-related information included in the cycle data acquired from a certain injection molding apparatus in a certain cycle includes N pieces of actual value information in addition to the apparatus identification information for identifying the injection molding apparatus. N may be any integer equal to or greater than 2. Each of the N pieces of actual value information is information indicating one or more types of actual values for each detection quantity controlled by the injection molding apparatus. Here, each of the one or more types of actual values for a certain detection quantity indicates a feature of a waveform indicating a temporal change in a value of the detection quantity, and is, for example, a minimum value of the detection quantity, a maximum value, an average value, a variance, a standard deviation, a start value of a period in which the detection quantity is detected, or an end value of the period, but is not limited thereto. For example, an actual value of the injection speed, which is an example of the detection quantity, is a maximum injection speed which is a maximum value of the injection speed, an average injection speed which is an average value of the injection speed, or the like, but is not limited thereto. Further, for example, an actual value of the injection holding pressure, which is an example of the detection quantity, is a maximum injection holding pressure which is a maximum value of the injection holding pressure, an average injection holding pressure which is an average value of the injection holding pressure, or the like, but is not limited thereto. Further, for example, an actual value of a position of the screw, which is an example of the detection quantity, is an injection start position which is a position of the screw when the injection of the material is started in the injection molding process of the cycle, an injection end position which is a position of the screw when the injection of the material is ended in the injection molding process of the cycle, a V-P switching position which is a position of the screw for switching from speed control for controlling the position of the screw while keeping the injection speed constant to pressure control for controlling the position of the screw while keeping the injection holding pressure constant, or the like, but is not limited thereto. An actual value for a certain detection quantity may be a value of the detection quantity itself. For example, an actual value of the cycle time, which is an example of the detection quantity, is a value of the cycle time itself. Further, for example, an actual value of the filling time, which is an example of the detection quantity, is a value of the filling time itself. One or more types of actual values for a certain detection quantity are values controlled by the injection molding apparatus because the detection quantity is a quantity controlled by the injection molding apparatus.

Further, the plurality of pieces of cycle-related information included in the cycle data acquired from a certain injection molding apparatus in a certain cycle may include M pieces of time-series information in addition to the apparatus identification information for identifying the injection molding apparatus and the N pieces of actual value information. Each of the M pieces of time-series information is information indicating a time series of any of M detection quantities. When the M pieces of time-series information are included in the plurality of pieces of cycle-related information, the plurality of pieces of cycle-related information may not include the N pieces of actual value information. This is because the information processing device 20 can calculate the actual value indicated by each of the N pieces of actual value information from the M pieces of time-series information. In this case, the M pieces of time-series information are treated as substitutes for the N pieces of actual value information. That is, in this case, in the information processing device 20, the actual value information indicating each of one or more types of actual values for a certain detection quantity is time-series information indicating a time series of the detection quantity. Hereinafter, as an example, a case in which the plurality of pieces of cycle-related information includes M pieces of time-series information and N pieces of actual value information will be described.

The plurality of pieces of cycle-related information included in the cycle data acquired from a certain injection molding apparatus in a certain cycle may include other information. The other information is, for example, a part or all of operation state information, product quantity information, job number information, or cycle count information, abnormality occurrence information, and defect occurrence information, but is not limited thereto. Here, the operation state information included in the cycle data as the cycle-related information is information indicating an operation state of the injection molding apparatus. The product quantity information included in the cycle data as the cycle-related information is information indicating the number of products injection-molded by the injection molding apparatus in the cycle. The job number information is information indicating a job number for identifying a job to which a cycle to be executed belongs. The cycle count information is information indicating a cycle count. The cycle count is a number indicating an order in which the cycle is executed. The abnormality occurrence information is information indicating whether an abnormality occurs in the cycle. The defect occurrence information is information indicating whether a defect occurs in the cycle, depending on the number of defective products generated in the products injection-molded in the cycle.

The cycle data as described above can be distinguished by a combination of the apparatus identification information and the first date-and-time information. When there is only one injection molding apparatus coupled to the information processing device 20, the cycle data may not include the apparatus identification information. This is because, in this case, the cycle data can be distinguished simply by the first date-and-time information.

When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires the injection molding condition data from each of the one or more injection molding apparatuses in the plurality of managed devices 10 every time an injection molding condition is set in the corresponding injection molding apparatus.

Here, the injection molding condition data acquired from a certain injection molding apparatus is information in which a plurality of pieces of injection molding condition information each indicating the injection molding condition set in the injection molding apparatus, the apparatus identification information for identifying the injection molding apparatus, and second date-and-time information indicating an acquisition date and time when the injection molding condition data is acquired by the information processing device 20 from the injection molding apparatus are associated with one another. The apparatus identification information is, for example, an ID for identifying the injection molding apparatus, but may be other information through which the injection molding apparatus can be identified, such as an IP address assigned to the injection molding apparatus. The second date-and-time information may be a time stamp or other information indicating the acquisition date and time. The injection molding condition data may include other information in addition to the plurality of pieces of injection molding condition information, the apparatus identification information, and the second date-and-time information. A part of the plurality of types of information included in the injection molding condition data may be included in the injection molding condition data as metadata. A data amount of the injection molding condition data may be calculated based on a data amount of each of the plurality of types of information included in the injection molding condition data, or may be specified by data amount information indicating a data amount included in the injection molding condition data. The apparatus identification information may be included in the injection molding condition data as any piece of the plurality of pieces of injection molding condition information. Hereinafter, as an example, a case in which the apparatus identification information is included in the injection molding condition data as any piece of the plurality of pieces of injection molding condition information will be described.

The plurality of pieces of injection molding condition information included in the injection molding condition data acquired from a certain injection molding apparatus include M pieces of target value information in addition to the apparatus identification information for identifying the injection molding apparatus. Each of the M pieces of target value information is information indicating one or more target values in the control for each detection quantity performed by the injection molding apparatus. Therefore, the target value information indicating one or more target values for a certain detection quantity is associated with the detection quantity. A method of associating the detection quantity with the target value information may be a known method or a method to be developed in the future. A reason why the M pieces of target value information are included in the injection molding condition data as the injection molding condition information is that the injection molding apparatus controls the detection quantity such that the value of the detection quantity matches the target value of the detection quantity for each detection quantity in each cycle. Here, a reason why there are one or more target values for each detection quantity is that there may be a plurality of target values as targets to which each detection quantity is to be brought close in the control performed by the injection molding apparatus in each cycle. For example, the injection speed, which is an example of the detection quantity, changes in a plurality of stages in the injection molding process of each cycle. In such a case, there are a plurality of target values for the detection quantity. The target value information for a certain detection quantity indicates each of the one or more target values for the detection quantity. Therefore, the injection molding condition data includes, as the injection molding condition information, the target value information of the same pieces as the number of detection units attached to the injection molding apparatus. Hereinafter, for convenience of description, each of the one or more target values for a certain detection quantity is referred to as a target value corresponding to the detection quantity. Therefore, hereinafter, for convenience of description, the detection quantity is referred to as a detection quantity corresponding to the one or more target values.

The plurality of pieces of injection molding condition information included in the injection molding condition data acquired from a certain injection molding apparatus may include other information in addition to the apparatus identification information for identifying the injection molding apparatus and the M pieces of target value information. The other information is abnormality determination condition information associated with each target value set as the injection molding condition in the injection molding apparatus or the like, but is not limited thereto. Here, the abnormality determination condition information associated with a certain target value is information indicating an abnormality determination condition satisfied by a value of a detection quantity corresponding to the target value when no abnormality occurs in the value of the detection quantity in the control in which the injection molding apparatus causes the value of the detection quantity to match the target value. A method of associating the target value with the abnormality determination condition information may be a known method or a method to be developed in the future. The abnormality determination condition may be any condition as long as the condition is satisfied by the value of the detection quantity when no abnormality occurs in the value of the detection quantity in the control.

The injection molding condition data as described above can be distinguished by a combination of the apparatus identification information and the second date-and-time information. When there is only one injection molding apparatus coupled to the information processing device 20, the injection molding condition data may not include the apparatus identification information. This is because, in this case, each piece of injection molding condition data can be distinguished simply by the second date-and-time information.

When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30. Here, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed in the future. By such association, with each piece of cycle data, at least one piece of injection molding condition data is associated. Hereinafter, as an example, a case in which one piece of injection molding condition data is associated with each piece of cycle data will be described. The injection molding condition data may not be associated with each piece of cycle data.

In response to a request from the terminal device communicably connected to the information processing device 20, the information processing device 20 displays, on a display unit of the terminal device, various images based on the data stored in the information processing device 20. The data may be the cycle data, the injection molding condition data, both of these two types of data, or other data. Here, the images are a graphical user interface (GUI), an icon, a window on an operating system (OS), and the like. Hereinafter, as an example, a case in which the information processing device 20 is communicably connected to a terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing in response to a received operation means the information processing device 20 performing the processing in response to an operation received from the terminal device 40 via the image displayed on the terminal device 40.

Examples of the information processing device 20 include, but are not limited to, a workstation, a desktop personal computer (PC), and a notebook PC. The information processing device 20 is communicably connected to each of the plurality of managed devices 10 by wired or wireless communication. Examples of a communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the data stored in the server 30. The data may be the cycle data, the injection molding condition data, both of these two types of data, or other data. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing in response to a received operation means the server 30 performing the processing in response to an operation received from the terminal device 40 via the image displayed on the terminal device 40.

As described above, in the molding management system 1, both the information processing device 20 and the server 30 display, in response to the received operation, various images based on the stored data on the display unit of the terminal device 40. Therefore, hereinafter, for convenience of description, the information processing device 20 and the server 30 are collectively referred to as an information processing device X unless it is necessary to distinguish the information processing device 20 and the server 30. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

Here, the information processing device X displays, by a received operation, a data amount display image P1 including a graph indicating a data amount of each piece of data classified by a classification method desired by the user. More specifically, when receiving a predetermined operation, the information processing device X displays a classification target data type reception image for receiving a type of data to be classified. The classification target data type reception image may be any image, as long as the type of data to be classified can be received via the image. When receiving the type of data to be classified via the classification target data type reception image, the information processing device X deletes the display of the classification target data type reception image and displays a first classification condition reception image for receiving a first operation. Hereinafter, for convenience of description, data of the type received via the classification target data type reception image is referred to as classification target data. Examples of the classification target data include, but are not limited to, the cycle data, the injection molding condition data, and both the cycle data and the injection molding condition data. The first operation is an operation of designating a first classification condition for classifying the stored data. The first classification condition reception image may be any image, as long as the first operation can be received via the image. The first classification condition that can be designated by the first operation includes, for example, at least one of distinguishing by each injection molding apparatus serving as an acquisition source, distinguishing by each acquisition date and time, distinguishing by each search frequency, distinguishing by each download frequency, distinguishing by each 4M (Man, Machine, Method, Material), distinguishing by each abnormality ratio that is a ratio at which an abnormality occurs, and distinguishing by each defect ratio that is a ratio at which a defect occurs. The first classification condition that can be designated by the first operation may include another condition for classifying the data stored in the information processing device X, instead of a part or all of these conditions or in addition to all of these conditions.

In an example, since the first classification condition that can be designated by the first operation includes distinguishing by each search frequency and distinguishing by each download frequency, the information processing device X stores information indicating each of a search history and a download history for each piece of stored data. Therefore, the information processing device X can classify the stored data to be distinguishable by each search frequency and classify the stored data to be distinguishable by each download frequency.

When the first operation is received via the first classification condition reception image, the information processing device X deletes the display of the first classification condition reception image and specifies the first classification condition designated by the first operation. The information processing device X classifies the classification target data based on the specified first classification condition. For example, when the first classification condition designated by the first operation is to distinguish by each injection molding apparatus serving as the acquisition source, the information processing device X classifies the classification target data to be distinguishable by each injection molding apparatus serving as the acquisition source. Further, for example, when the first classification condition designated by the first operation is to distinguish by each acquisition date and time, the information processing device X classifies the classification target data to be distinguishable by each acquisition date and time. Further, for example, when the first classification condition designated by the first operation is to distinguish by each abnormality ratio, the classification target data is classified to be distinguishable by each abnormality ratio. Hereinafter, for convenience of description, the data classified based on the first classification condition is referred to as first post-classification data. That is, the information processing device X classifies the classification target data into a plurality of types of first post-classification data based on the specified first classification condition. The first classification condition may include a condition of distinguishing by each of two or more types of information designated by the user among the information included in the data described in the present specification. In this case, the information processing device X receives two or more types of information designated by the user via the first classification condition reception image. Here, information designated as the two or more types of information is, for example, the time-series information, the data amount information, the job number information, and the cycle count information, but is not limited thereto.

The information processing device X classifies the classification target data into a plurality of types of first post-classification data based on the first classification condition, and then generates a graph indicating a data amount of each of the plurality of types of first post-classification data. The graph may be, for example, a bar graph, a pie chart, a calendar heat map, or a graph of another type. Further, the type of the graph generated by the information processing device X may be configured to be designated by the user or may be configured not to be designated by the user. When the type cannot be designated by the user, the type is determined in advance for each piece of the classification target data.

After generating the graph indicating the data amount of each piece of the first post-classification data, the information processing device X generates the data amount display image P1 including the generated graph and displays the generated data amount display image P1. Accordingly, the information processing device X can display a data amount of each piece of data classified according to a desired classification condition. This means that the data amount of each breakdown of the data can be displayed. As a result, the information processing device X can reduce the time and effort required for a system administrator or the like to manage the data.

Here, FIG. 2 is a diagram showing a first example of the data amount display image P1. A graph G1, which is an example of the graph generated by the information processing device X, is displayed in the data amount display image P1 shown in FIG. 2. In the graph G1, the first post-classification data is the cycle data classified to be distinguishable by each acquisition date and time. Further, the classification target data is the cycle data in which an injection molding apparatus identified by "apparatus 1", which is an example of the apparatus identification information, is the acquisition source. The graph G1 is a bar graph. A vertical axis of the graph G1 represents a data amount of each piece of the first post-classification data. A horizontal axis of the graph G1 represents each section obtained by dividing a period from Year 2023 to Year 2024 in a unit of one month. The graph G1 may have a configuration in which a width of each section can be changed by the user or may have a configuration in which the width of each section cannot be changed by the user. For example, in the graph G1, a data amount of the cycle data included in a section in which a date and time indicated by the first date-and-time information, that is, an acquisition date and time is January 2023, is 50000 Kbytes. In this way, the information processing device X can display a bar graph indicating a data amount of each piece of the cycle data classified to be distinguishable by each acquisition date and time. Accordingly, the information processing device X can easily specify an acquisition date and time of the cycle data having a large data amount. For example, based on the graph G1, the information processing device X can easily search for the cycle data having a largest data amount as the cycle data to be deleted. As a result, the information processing device X can reduce the time and effort required for the system administrator or the like to manage the data.

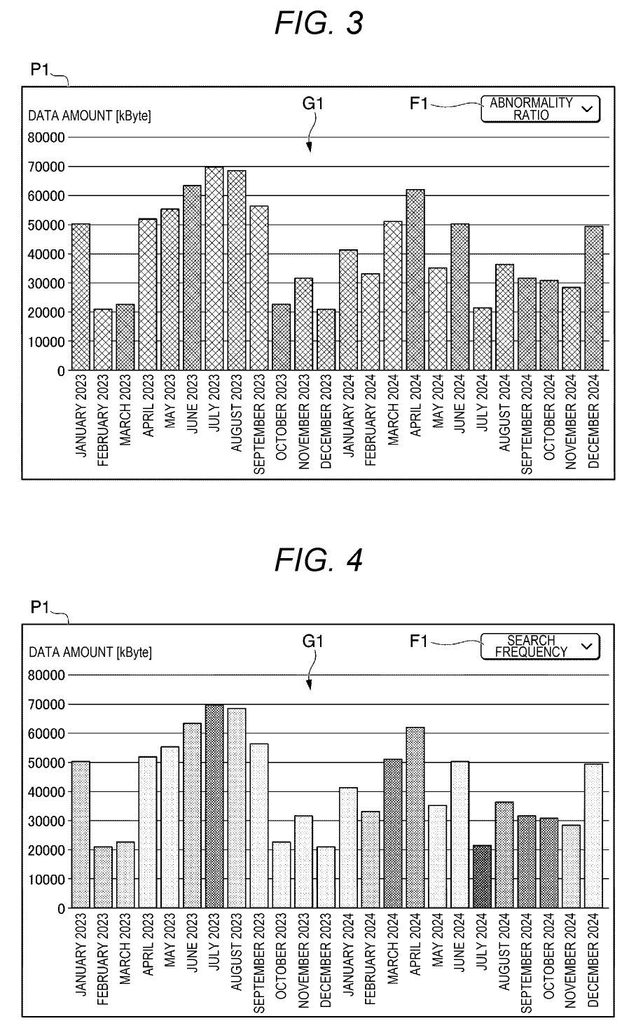

The data amount display image P1 may include a second classification condition information reception image F1 for receiving second classification condition information indicating a second classification condition. FIG. 3 is a diagram showing an example of the data amount display image P1 including the second classification condition information reception image F1. The graph G1 shown in FIG. 3 is the same as the graph G1 shown in FIG. 2. Hereinafter, for convenience of description, an operation of receiving the second classification condition information via the second classification condition information reception image F1 is referred to as a second operation. That is, the second operation is an operation of designating the second classification condition.

Here, the second classification condition is a condition for further classifying each piece of the first post-classification data displayed in the graph G1. The second classification condition that can be designated by the second operation includes at least one of distinguishing by each injection molding apparatus serving as the acquisition source, distinguishing by each acquisition date and time, distinguishing by each search frequency, distinguishing by each download frequency, distinguishing by each 4M, distinguishing by each abnormality ratio that is a ratio at which an abnormality occurs, and distinguishing by each defect ratio that is a ratio at which a defect occurs. The second classification condition that can be designated by the second operation may include another condition for classifying the data stored in the information processing device X, instead of a part or all of these conditions or in addition to all of these conditions. However, the second classification condition that can be designated by the second operation is a condition different from the first classification condition designated by the first operation.

The second classification condition information reception image F1 is a field for inputting the second classification condition information desired by the user. In the example shown in FIG. 3, "abnormality ratio" is input to the second classification condition information reception image F1 as an example of the second classification condition information. The "abnormality ratio" is an example of the second classification condition information indicating a second classification condition of distinguishing by each abnormality ratio. The second classification condition information may be input to the second classification condition information reception image F1 by selecting the second classification condition information from a pull-down menu, or may be directly input using an input device such as a keyboard. The second classification condition information reception image F1 may be any GUI as long as the second classification condition information desired by the user can be input via the GUI. When the second classification condition information is received via the second classification condition information reception image F1, the information processing device X specifies the second classification condition indicated by the second classification condition information. The information processing device X classifies the first post-classification data displayed in the graph G1, based on the specified second classification condition. For example, when the second classification condition designated by the second operation is to distinguish by each abnormality ratio, each piece of the first post-classification data is classified to be distinguishable by each abnormality ratio. For example, when the second classification condition designated by the second operation is to distinguish by each defect ratio, each piece of the first post-classification data is classified to be distinguishable by each defect ratio. Hereinafter, for convenience of description, the data classified based on the second classification condition is referred to as second post-classification data. The second classification condition may include a condition of distinguishing by each of two or more types of information designated by the user among the information included in the data described in the present specification. In this case, the information processing device X receives two or more types of information designated by the user via the second classification condition information reception image F1. Here, information designated as the two or more types of information is, for example, the time-series information, the data amount information, the job number information, and the cycle count information, but is not limited thereto.

When the first classification condition is to distinguish by each acquisition date and time and the second classification condition is to distinguish by each abnormality ratio, for example, as shown in FIG. 3, the information processing device X calculates, for each section in the graph G1, an abnormality ratio of the first post-classification data included in the corresponding section. The abnormality ratio of the first post-classification data included in a certain section is a ratio obtained by dividing the number of pieces of the first post-classification data including the abnormality occurrence information among the first post-classification data included in the section by the number of pieces of the first post-classification data included in the section. Hereinafter, for convenience of description, the abnormality ratio of the first post-classification data included in a certain section is referred to as an abnormality ratio of the section. The information processing device X makes display modes of a plurality of types of second post-classification data, obtained as a result of classifying the plurality of types of first post-classification data according to the abnormality ratio calculated for each section, different. For example, when an abnormality ratio of a first section among the sections displayed in the graph G1 is different from an abnormality ratio of a second section different from the first section among the sections displayed in the graph G1, the information processing device X classifies the first post-classification data of the first section and the first post-classification data of the second section into two different types of second post-classification data, and makes display modes of the two types of second post-classification data different from each other. In other words, for example, in this case, the information processing device X sets the first post-classification data of the first section as the second post-classification data of a first type, sets the first post-classification data of the second section as the second post-classification data of a second type, and makes a display mode of the second post-classification data of the first type different from a display mode of the second post-classification data of the second type. More specifically, for example, the information processing device X makes a type of color of the second post-classification data of the first type different from a type of color of the second post-classification data of the second type. For example, the information processing device X may be configured to make a shade of the color of the second post-classification data of the first type different from a shade of the color of the second post-classification data of the second type. Further, the information processing device X may be configured to make the type and the shade of the color of the second post-classification data of the first type different from the type and the shade of the color of the second post-classification data of the second type. Further, for example, when the abnormality ratio of the first section among the sections displayed in the graph G1 is the same as the abnormality ratio of the second section different from the first section among the sections displayed in the graph G1, the information processing device X classifies the first post-classification data of the first section and the first post-classification data of the second section into the same second post-classification data, and sets the display mode of the second post-classification data of the first section and the display mode of the second post-classification data of the second section to the same display mode. In the example shown in FIG. 3, the information processing device X classifies the first post-classification data displayed in the sections on the graph G1 into a plurality of types of second post-classification data based on the abnormality ratio calculated for each section, and makes shades of color of the plurality of types of second post-classification data different from each other. Accordingly, the information processing device X can easily specify the cycle data in which the abnormality occurs. This leads to a reduction in time required for the system administrator or the like to solve a problem when an abnormality occurs, and is useful.

In such a data amount display image P1, the user can change the second classification condition displayed in the second classification condition information reception image F1 to another second classification condition by an operation on the second classification condition information reception image F1. FIG. 4 is a diagram showing an example of the data amount display image P1 immediately after the second classification condition is changed. The data amount display image P1 shown in FIG. 4 is the same as the data amount display image P1 shown in FIG. 3 except that the second classification condition information displayed in the second classification condition information reception image F1 is different. In the example shown in FIG. 4, "search frequency" is input to the second classification condition information reception image F1 as an example of the second classification condition information. The "search frequency" is an example of the second classification condition information indicating a second classification condition of distinguishing by each search frequency. For example, the user changes the second classification condition information by selecting the second classification condition information in a pull-down menu in the second classification condition information reception image F1. When the second classification condition information displayed in the second classification condition information reception image F1 is changed, the information processing device X reclassifies the plurality of types of first post-classification data, and makes display modes of a plurality of types of second post-classification data after the reclassification different from each other.

When the first classification condition is to distinguish by each acquisition date and time and the second classification condition is to distinguish by each search frequency, for example, as shown in FIG. 4, the information processing device X calculates, for each section in the graph G1, an average value of search frequencies of the first post-classification data included in the corresponding section based on the information indicating the search history of the first post-classification data included in the corresponding section. Hereinafter, for convenience of description, the average value of the search frequencies of the first post-classification data included in a certain section is referred to as a search frequency of the section. The information processing device X makes display modes of a plurality of types of second post-classification data, obtained as a result of classifying the plurality of types of first post-classification data according to the search frequency calculated for each section, different. For example, when a search frequency of a first section among the sections displayed in the graph G1 is different from a search frequency of a second section among the sections displayed in the graph G1, the information processing device X classifies the first post-classification data of the first section and the first post-classification data of the second section into two different types of second post-classification data, and makes display modes of the two types of second post-classification data different from each other. In other words, for example, in this case, the information processing device X sets the first post-classification data of the first section as the second post-classification data of a first type, sets the first post-classification data of the second section as the second post-classification data of a second type, and makes a display mode of the second post-classification data of the first type different from a display mode of the second post-classification data of the second type. More specifically, for example, the information processing device X makes a type of color of the second post-classification data of the first type different from a type of color of the second post-classification data of the second type. For example, the information processing device X may be configured to make a shade of the color of the second post-classification data of the first type different from a shade of the color of the second post-classification data of the second type. Further, the information processing device X may be configured to make the type and the shade of the color of the second post-classification data of the first type different from the type and the shade of the color of the second post-classification data of the second type. Further, for example, when the search frequency of the first section among the sections displayed in the graph G1 is the same as the search frequency of the second section among the sections displayed in the graph G1, the information processing device X classifies the first post-classification data of the first section and the first post-classification data of the second section into the same second post-classification data, and sets the display mode of the second post-classification data of the first section and the display mode of the second post-classification data of the second section to the same display mode. In the example shown in FIG. 4, the information processing device X classifies the first post-classification data displayed in the sections on the graph G1 into a plurality of types of second post-classification data based on the search frequency calculated for each section, and makes shades of color of the plurality of types of second post-classification data different from each other. Accordingly, the information processing device X can easily specify the cycle data having a high search frequency, that is, the cycle data having a high use frequency. This leads to a reduction in time and effort of the system administrator or the like when deleting data having a low use frequency, and is useful.

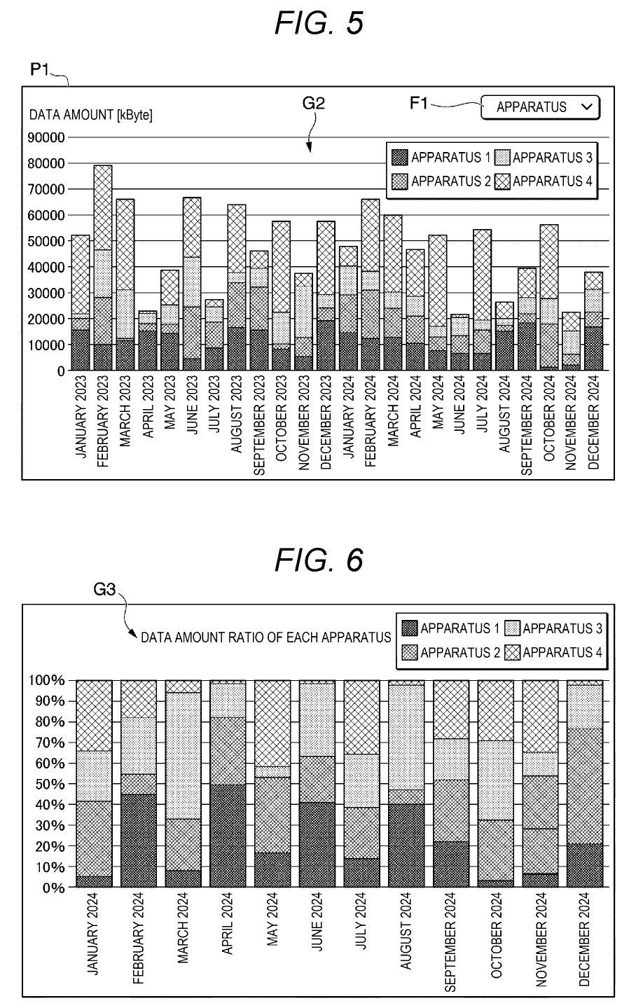

Meanwhile, FIG. 5 is a diagram showing another example of the data amount display image P1 immediately after the second classification condition is changed. Instead of the graph G1, a graph G2 generated by the information processing device X is displayed in the data amount display image P1 shown in FIG. 5. However, the graph G2 is the same graph as the graph G1 except that the cycle data in which injection molding apparatuses identified by "apparatus 1" to "apparatus 4", which are examples of the apparatus identification information, are the acquisition sources, is used as the classification target data. Therefore, a detailed description of the graph G2 will be omitted. Meanwhile, in the second classification condition information reception image F1 included in the data amount display image P1, "apparatus" is input as an example of the second classification condition information. The "apparatus" is an example of the second classification condition information indicating a second classification condition of distinguishing by each injection molding apparatus serving as the acquisition source.

When the first classification condition is to distinguish by each acquisition date and time and the second classification condition is to distinguish by each injection molding apparatus serving as the acquisition source, for example, as shown in FIG. 5, the information processing device X specifies, for each section in the graph G2, the injection molding apparatuses each serving as the acquisition source in the first post-classification data included in the corresponding section. A method of specifying the injection molding apparatus serving as the acquisition source in each piece of the first post-classification data may be a known method or a method to be developed in the future. After specifying, for each section, the injection molding apparatuses serving as the acquisition sources in the first post-classification data included in the corresponding section, the information processing device X classifies, for each section, data included as the first post-classification data in the corresponding section into the second post-classification data of each injection molding apparatus serving as the acquisition source. Then, the information processing device X displays, for each section, the graph G2 as a stacked bar graph by making the display modes of the plurality of types of second post-classification data in the corresponding section different from each other. Therefore, the graph G2 shown in FIG. 5 is a graph in which the first post-classification data can be distinguished as the second post-classification data of each injection molding apparatus serving as the acquisition source, in each section. For example, the information processing device X makes shades of color of the second post-classification data of the respective injection molding apparatuses serving as the acquisition sources in each section different from each other. The information processing device X may be configured to make types of the color of the second post-classification data of the respective injection molding apparatuses serving as the acquisition sources in each section different from each other, or may be configured to make both the types and the shades of the color of the second post-classification data of the respective injection molding apparatuses serving as the acquisition sources in each section different from each other. Accordingly, the information processing device X can easily specify the injection molding apparatus serving as the acquisition source in the cycle data occupying many storage areas among the stored cycle data. This leads to a reduction in time and effort of the system administrator or the like when reducing the data amount of the cycle data, and is useful.

The information processing device X may be configured to indicate a vertical axis of a graph such as the graph G1 or the graph G2 by percentage. That is, the information processing device X may be configured to indicate a data amount of each piece of the second post-classification data displayed in the graph by percentage.

FIG. 6 is a diagram showing an example of a graph indicating, by percentage, the data amount of the first post-classification data when the first classification condition is to distinguish by each acquisition date and time and the second classification condition is to distinguish by each injection molding apparatus serving as the acquisition source. A graph G3 shown in FIG. 6 is an example of the graph generated by the information processing device X, and is an example of the graph indicating the data amount of the first post-classification data by percentage in this case. Accordingly, the information processing device X can more reliably and easily specify the injection molding apparatus serving as the acquisition source in the second post-classification data which has a large data amount among the first post-classification data of each acquisition date and time.

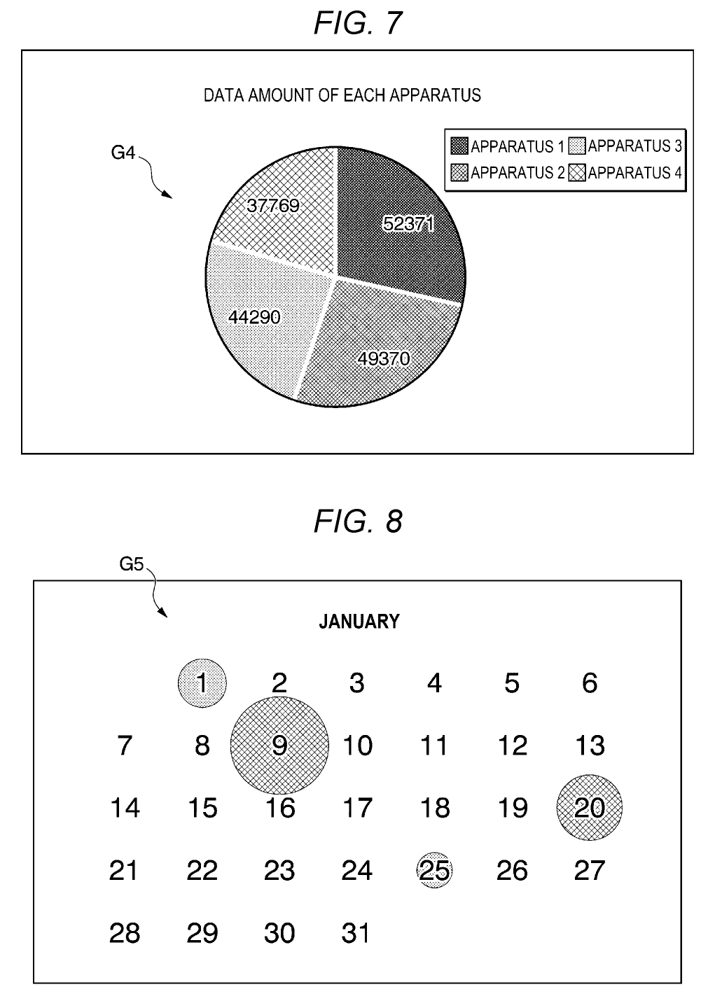

As described above, the information processing device X may be configured to generate a graph such as the graph G1 and the graph G2 as a pie chart instead of the bar graph. FIG. 7 is a diagram showing an example of a pie chart showing the data amount of the first post-classification data when the first classification condition is to distinguish by each injection molding apparatus serving as the acquisition source. A graph G4 shown in FIG. 7 is an example of the pie chart. In the graph G4, the first post-classification data is cycle data classified to be distinguishable by each injection molding apparatus serving as the acquisition source. As shown in FIG. 7, the information processing device X can easily and visually compare the data amounts of the respective pieces of first post-classification data by displaying the pie chart indicating the data amounts of the respective pieces of first post-classification data in the data amount display image P1.

Here, the information processing device X may be configured to, when receiving a selection operation on a region corresponding to any piece of first post-classification data among the first post-classification data displayed in the graph G4, display accompanying information accompanying the first post-classification data corresponding to the region on which the selection operation is received. The accompanying information may be any information as long as being information accompanying the first post-classification data, and is, for example, information including at least one of period information indicating a period in which the first post-classification data is acquired and type information indicating a type of the first post-classification data. In this case, the information processing device X may be configured to display another type of graph such as a bar graph of the first post-classification data. For example, in this case, the information processing device X may be configured to re-classify the first post-classification data to be distinguishable by each acquisition date and time, and display a bar graph indicating a data amount of each piece of the re-classified first post-classification data. Further, in this case, the information processing device X may be configured to perform another process related to the first post-classification data corresponding to the region on which the selection operation is received.

As described above, the information processing device X may be configured to generate a graph such as the graph G1 and the graph G2 as a calendar heat map instead of the bar graph. FIG. 8 is a diagram showing an example of a calendar heat map indicating the data amount of the first post-classification data when the first classification condition is to distinguish by each acquisition date and time. A graph G5 shown in FIG. 8 is an example of the calendar heat map. In the graph G5, the first post-classification data is the cycle data classified to be distinguishable by each acquisition date and time. As shown in FIG. 8, the information processing device X displays the graph G5 in which a figure in a display mode indicating the data amount of each piece of the first post-classification data is displayed in association with a numerical value indicating a date. That is, the calendar heat map is a graph in which the figure in the display mode indicating the data amount of each piece of the first post-classification data is displayed in association with the numerical value indicating a date. By displaying the calendar heat map indicating the data amount of each piece of the first post-classification data in the data amount display image P1, the information processing device X can easily and visually compare the date and time when the cycle data having a large data amount is acquired.

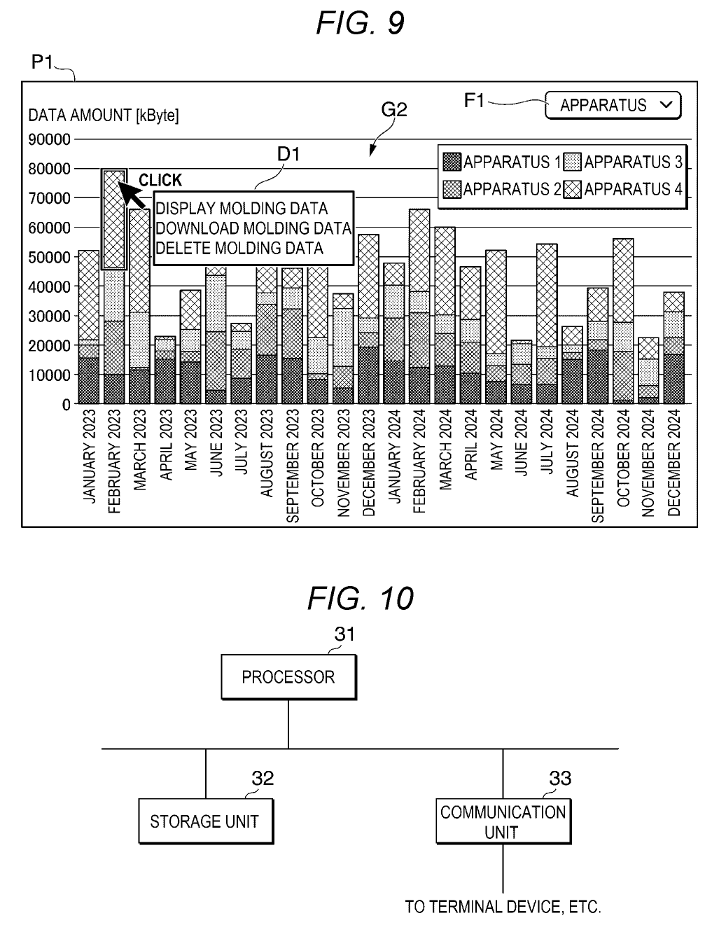

Further, the information processing device X may be configured to display, when receiving an operation of selecting a region corresponding to at least a part of the first post-classification data displayed in the graph in the data amount display image P1, an image for receiving at least one of search and deletion of the first post-classification data corresponding to the region. Here, the second post-classification data described above is an example of at least a part of the first post-classification data. FIG. 9 is a diagram showing an example of a state of the data amount display image P1 immediately after an operation of selecting a region corresponding to a part of the first post-classification data displayed in the graph G2 shown in FIG. 5. In the example shown in FIG. 9, the information processing device X receives, from the user, an operation of selecting a region corresponding to the cycle data acquired from the injection molding apparatus identified by "apparatus 4" among the cycle data included in a section in which the acquisition date and time is February 2023. The cycle data in which the acquisition date and time is included in the section of February 2023 is an example of the first post-classification data in which the acquisition date and time is included in a period from February 2023 to March 2023. Further, the cycle data acquired from the injection molding apparatus identified by "apparatus 4" is an example of the second post-classification data acquired from the injection molding apparatus among the data included in the first post-classification data. In this case, the information processing device X displays an image D1 in the data amount display image P1 as shown in FIG. 9. The image D1 is an image for receiving an operation of performing any one of searching for the cycle data corresponding to the region, downloading the cycle data corresponding to the region, and deleting the cycle data corresponding to the region. For example, when a selection operation on a character string "display molding data" in the image D1 is received, the information processing device X searches for the cycle data corresponding to the region, that is, the cycle data acquired from the injection molding apparatus identified by "apparatus 4" among the cycle data included in the section in which the acquisition date and time is February 2023. Then, the information processing device X displays the cycle data as a result of the search. The cycle data may be displayed in any mode as long as at least a part of the cycle data can be displayed. Further, for example, when a selection operation on a character string "download molding data" in the image D1 is received, the information processing device X downloads the cycle data corresponding to the region, that is, the cycle data acquired from the injection molding apparatus identified by "apparatus 4" among the cycle data included in the section in which the acquisition date and time is February 2023. The cycle data may be downloaded by any method. Further, for example, when a selection operation on a character string "delete molding data" in the image D1 is received, the information processing device X deletes, from the storage area, the cycle data corresponding to the region, that is, the cycle data acquired from the injection molding apparatus identified by "apparatus 4" among the cycle data included in the section in which the acquisition date and time is February 2023. The information processing device 20 may be configured to, when the cycle data is deleted, also delete the cycle data from the storage area of the server 30, or not to delete the cycle data from the storage area of the server 30. Further, the server 30 may be configured to, when the cycle data is deleted, also delete the cycle data from the storage area of the information processing device 20, or not to delete the cycle data from the storage area of the information processing device 20. The image D1 may be configured to be capable of receiving other operations.

### Hardware Configuration of Information Processing Device X

Here, the information processing device 20 and the server 30 may have the same hardware configuration or may have different hardware configurations. Hereinafter, as an example, a case in which the information processing device 20 and the server 30 have the same hardware configuration will be described. In other words, in one example, the information processing device X has a hardware configuration as shown in FIG. 10. FIG. 10 is a diagram showing an example of the hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a universal serial bus (USB). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### Functional Configuration of Information Processing Device X

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 11. FIG. 11 is a diagram showing an example of the functional configuration of the information processing device X.

The information processing device X includes the storage unit 32, the communication unit 33, and a control unit 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large-scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires the injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the data amount display image P1 and the like. The display control unit 343 transmits the generated images to the terminal device 40 to display the images on the terminal device 40.

The output control unit 344 outputs various types of data to another device in response to the received operation.

### Processing Performed by Information Processing Device X in Response to Received Operation

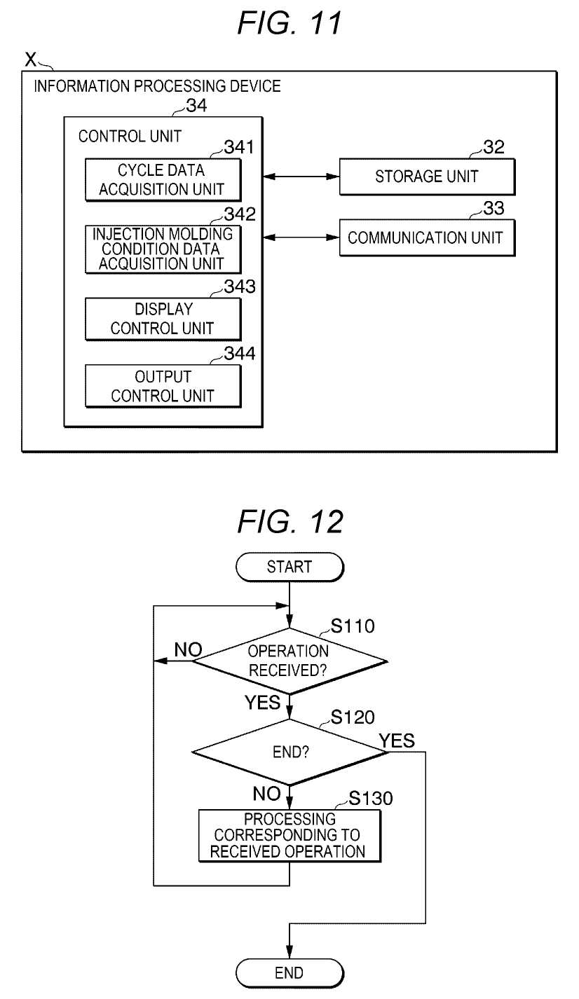

Referring to FIG. 12, processing performed by the information processing device X in response to each operation described above will be described. FIG. 12 is a diagram showing an example of a flow of the processing performed by the information processing device X in response to a received operation. Hereinafter, as an example, a case will be described in which the information processing device X is in a state in which various operations from the user can be received via the terminal device 40 at a timing before processing in step S110 shown in FIG. 12 is performed. Hereinafter, as an example, a case in which a plurality of pieces of cycle data and a plurality of pieces of injection molding condition data are already stored in the information processing device X at the timing will be described.

The control unit 34 waits until an operation is received via the terminal device 40 (step S110). In FIG. 12, the processing in step S110 is indicated by "operation received?".

When it is determined that the operation has been received via the terminal device 40 (step S110: YES), the control unit 34 determines whether the received operation is an operation for ending the processing in the flowchart shown in FIG. 12 (step S120). The determination processing may be performed by the control unit 34 in step S120 by a known method or by a method to be developed in the future. In FIG. 12, the processing in step S120 is indicated by "end?".

When it is determined that the operation received in step S110 is an operation for ending the processing in the flowchart shown in FIG. 12 (step S120: YES), the control unit 34 ends the processing in the flowchart shown in FIG. 12.

On the other hand, when it is determined that the operation received in step S110 is not an operation for ending the processing in the flowchart shown in FIG. 12 (step S120: NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIGS. 2 to 9, a detailed description of the processing will be omitted.

After the processing in step S130 is performed, the control unit 34 transitions to step S110 and waits again until an operation is received via the terminal device 40.

By the processing as described above, the information processing device X stores one or more pieces of data acquired from the injection molding apparatus, classifies the data based on the first classification condition designated by the received first operation, and displays a graph indicating a data amount of each piece of the classified data. Accordingly, the information processing device X can display a data amount of each piece of data classified according to a desired classification condition. This means that the data amount of each breakdown of the data can be displayed. As a result, the information processing device X can reduce the time and effort required for the system administrator or the like to manage the data.

The molding management system 1 described above may include the terminal device 40. The molding management system 1 described above may include an injection molding apparatus such as the injection molding apparatus 11.

The contents described above may be combined in any manner.

### APPENDIX

A molding management system for managing production of a product in a production process including an injection molding process of the product performed by an injection molding apparatus, the molding management system including an information processing device communicably connected to a terminal device, in which the information processing device includes a storage unit configured to store one or more pieces of data acquired from the injection molding apparatus, and a control unit configured to classify, based on a first classification condition designated by a first operation that is received, the data into a plurality of types of first post-classification data and display, on a display unit, a graph indicating a data amount of each of the plurality of types of first post-classification data that are classified.

The molding management system according to [1], in which the data includes a plurality of types of information related to injection molding.

The molding management system according to [1] or [2], in which the first classification condition that is able to be designated by the first operation includes at least one of distinguishing by each injection molding apparatus serving as an acquisition source, distinguishing by each acquisition date and time, distinguishing by each search frequency, distinguishing by each download frequency, distinguishing by each 4M, distinguishing by each abnormality ratio that is a ratio at which an abnormality occurs, and distinguishing by each defect ratio that is a ratio at which a defect occurs.

The molding management system according to any one of [1] to [3], in which regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and when the first classification condition designated by the first operation is to distinguish by each injection molding apparatus serving as the acquisition source, the information processing device displays, on the display unit as the graph, a bar graph indicating the data amount of each of the plurality of types of first post-classification data obtained as a result of classifying the data by each injection molding apparatus serving as the acquisition source.

The molding management system according to any one of [1] to [4], in which the information processing device classifies, based on a second classification condition designated by a second operation that is received, the plurality of types of first post-classification data displayed in the graph into a plurality of types of second post-classification data, and varies a display mode of each of the plurality of types of second post-classification data.

The molding management system according to [5], in which the second classification condition that is able to be designated by the second operation includes at least one of distinguishing by each injection molding apparatus serving as an acquisition source, distinguishing by each acquisition date and time, distinguishing by each search frequency, distinguishing by each download frequency, distinguishing by each 4M, distinguishing by each abnormality ratio that is a ratio at which an abnormality occurs, and distinguishing by each defect ratio that is a ratio at which a defect occurs, and the second classification condition that is able to be designated by the second operation is a condition different from the first classification condition.

The molding management system according to [5] or [6], in which regarding each of the plurality of types of second post-classification data, when the second classification condition designated by the second operation is to distinguish by each abnormality ratio that is a ratio at which an abnormality occurs, at least a part of the plurality of types of first post-classification data is classified according to the abnormality ratio calculated for each of the plurality of types of first post-classification data, and when the second classification condition designated by the second operation is to distinguish by each abnormality ratio, the information processing device makes any one or both of a type and a shade of color of each of the plurality of types of second post-classification data, obtained as a result of classifying the plurality of types of first post-classification data according to the abnormality ratio, different in the graph.

The molding management system according to any one of [5] to [7], in which regarding each of the plurality of types of first post-classification data, when the first classification condition designated by the first operation is to distinguish by each acquisition date and time, the data is classified according to the acquisition date and time of the data, regarding each of the plurality of types of second post-classification data, when the second classification condition designated by the second operation is to distinguish by each injection molding apparatus serving as an acquisition source, the data acquired from any of the injection molding apparatuses serving as the acquisition source of the data among the data included in each of the plurality of types of first post-classification data is classified, and when the first classification condition designated by the first operation is to distinguish by each acquisition date and time, and the second classification condition designated by the second operation is to distinguish by each injection molding apparatus serving as the acquisition source, the information processing device displays, on the display unit as the graph, a bar graph indicating the data amount of each of the plurality of types of first post-classification data obtained as a result of classifying the data by each acquisition date and time, and then displays the graph as a stacked bar graph by making a display mode of each of the plurality of types of second post-classification data, obtained as a result of classifying the plurality of types of first post-classification data by each injection molding apparatus serving as the acquisition source, different.

The molding management system according to [8], in which a vertical axis of the stacked bar graph indicates a data amount of each of the plurality of types of second post-classification data by percentage.

The molding management system according to any one of [1] to [9], in which regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and when the first classification condition designated by the first operation is to distinguish by each injection molding apparatus serving as the acquisition source, the information processing device displays, on the display unit as the graph, a pie chart indicating the data amount of each of the plurality of types of first post-classification data obtained as a result of classifying the data by each injection molding apparatus serving as the acquisition source.

The molding management system according to [10], in which when receiving a selection operation on a region corresponding to first data among the plurality of types of first post-classification data displayed in the pie chart, the information processing device displays, on the display unit, accompanying information accompanying the first data.

The molding management system according to [11], in which the accompanying information includes at least one of period information indicating a period in which the first data is acquired and type information indicating a type of the first data.

The molding management system according to any one of [1] to [12], in which regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and when the first classification condition designated by the first operation is to distinguish by each injection molding apparatus serving as the acquisition source, the information processing device displays, on the display unit, the graph in which a figure of a display mode indicating the data amount of each of the plurality of types of first post-classification data obtained as a result of classifying the data by each injection molding apparatus serving as the acquisition source is displayed in association with a numerical value indicating a date.

The molding management system according to [13], in which the graph is a calendar heat map.

The molding management system according to any one of [1] to [14], in which when receiving an operation of selecting a region corresponding to at least a part of the plurality of types of first post-classification data displayed in the graph, the information processing device displays, on the display unit, an image for receiving at least one of search and deletion of the data corresponding to the region.

The molding management system according to any one of [1] to [15], further including the terminal device.

The molding management system according to any one of [1] to [16], further including the injection molding apparatus.

The embodiment of the present disclosure is described in detail above with reference to the drawings. However, a specific configuration is not limited to the embodiment and may be, for example, changed, replaced, or deleted without departing from the gist of the present disclosure.

A program for implementing a function of any component in the device described above may be recorded in a computer-readable recording medium and the program may be read and executed by a computer system. Here, the device is, for example, the injection molding apparatus 11, the information processing device 20, the server 30, or the terminal device 40. Here, the "computer system" includes an operating system (OS) and hardware such as peripheral devices. The "computer-readable recording medium" refers to a portable medium such as a flexible disc, a magneto-optical disc, a ROM, or a compact disk (CD) ROM or a storage device such as a hard disk built in the computer system. Further, the "computer-readable recording medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system for managing production of a product in a production process including an injection molding process of the product performed by an injection molding apparatus, the molding management system comprising:
an information processing device communicably connected to a terminal device, wherein
the information processing device includes
a storage unit configured to store one or more pieces of data acquired from the injection molding apparatus, and
a control unit configured to classify, based on a first classification condition designated by a first operation that is received, the data into a plurality of types of first post-classification data and display, on a display unit, a graph indicating a data amount of each of the plurality of types of first post-classification data that are classified.

2. The molding management system according to claim 1, wherein
the data includes a plurality of types of information related to injection molding.

3. The molding management system according to claim 1, wherein
the first classification condition that is able to be designated by the first operation includes at least one of distinguishing by each injection molding apparatus serving as an acquisition source, distinguishing by each acquisition date and time, distinguishing by each search frequency, distinguishing by each download frequency, distinguishing by each 4M (man, machine, method and material), distinguishing by each abnormality ratio that is a ratio at which an abnormality occurs, and distinguishing by each defect ratio that is a ratio at which a defect occurs.

4. The molding management system according to claim 1, wherein
regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and
when the first classification condition designated by the first operation is to distinguish by each injection molding apparatus serving as the acquisition source, the information processing device displays, on the display unit as the graph, a bar graph indicating the data amount of each of the plurality of types of first post-classification data obtained as a result of classifying the data by each injection molding apparatus serving as the acquisition source.

5. The molding management system according to claim 1, wherein
the information processing device classifies, based on a second classification condition designated by a second operation that is received, the plurality of types of first post-classification data displayed in the graph into a plurality of types of second post-classification data, and varies a display mode of each of the plurality of types of second post-classification data.

6. The molding management system according to claim 5, wherein
the second classification condition that is able to be designated by the second operation includes at least one of distinguishing by each injection molding apparatus serving as an acquisition source, distinguishing by each acquisition date and time, distinguishing by each search frequency, distinguishing by each download frequency, distinguishing by each 4M (man, machine, method and material), distinguishing by each abnormality ratio that is a ratio at which an abnormality occurs, and distinguishing by each defect ratio that is a ratio at which a defect occurs, and
the second classification condition that is able to be designated by the second operation is a condition different from the first classification condition.

7. The molding management system according to claim 5, wherein
regarding each of the plurality of types of second post-classification data, when the second classification condition designated by the second operation is to distinguish by each abnormality ratio that is a ratio at which an abnormality occurs, at least a part of the plurality of types of first post-classification data is classified according to the abnormality ratio calculated for each of the plurality of types of first post-classification data, and
when the second classification condition designated by the second operation is to distinguish by each abnormality ratio, the information processing device makes any one or both of a type and a shade of color of each of the plurality of types of second post-classification data, obtained as a result of classifying the plurality of types of first post-classification data according to the abnormality ratio, different in the graph.

8. The molding management system according to claim 5, wherein
regarding each of the plurality of types of first post-classification data, when the first classification condition designated by the first operation is to distinguish by each acquisition date and time, the data is classified according to the acquisition date and time of the data,
regarding each of the plurality of types of second post-classification data, when the second classification condition designated by the second operation is to distinguish by each injection molding apparatus serving as an acquisition source, the data acquired from any of the injection molding apparatuses serving as the acquisition source of the data among the data included in each of the plurality of types of first post-classification data is classified, and
when the first classification condition designated by the first operation is to distinguish by each acquisition date and time, and the second classification condition designated by the second operation is to distinguish by each injection molding apparatus serving as the acquisition source, the information processing device displays, on the display unit as the graph, a bar graph indicating the data amount of each of the plurality of types of first post-classification data obtained as a result of classifying the data by each acquisition date and time, and then displays the graph as a stacked bar graph by making a display mode of each of the plurality of types of second post-classification data, obtained as a result of classifying the plurality of types of first post-classification data by each injection molding apparatus serving as the acquisition source, different.

9. The molding management system according to claim 8, wherein
a vertical axis of the stacked bar graph indicates a data amount of each of the plurality of types of second post-classification data by percentage.

10. The molding management system according to claim 1, wherein
regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and
when the first classification condition designated by the first operation is to distinguish by each injection molding apparatus serving as the acquisition source, the information processing device displays, on the display unit as the graph, a pie chart indicating the data amount of each of the plurality of types of first post-classification data obtained as a result of classifying the data by each injection molding apparatus serving as the acquisition source.

11. The molding management system according to claim 10, wherein
when receiving a selection operation on a region corresponding to first data among the plurality of types of first post-classification data displayed in the pie chart, the information processing device displays, on the display unit, accompanying information accompanying the first data.

12. The molding management system according to claim 11, wherein
the accompanying information includes at least one of period information indicating a period in which the first data is acquired and type information indicating a type of the first data.

13. The molding management system according to claim 1, wherein
regarding each of the plurality of types of first post-classification data, when the first classification condition designated by the first operation is to distinguish by each injection molding apparatus serving as an acquisition source, the data acquired from any of the injection molding apparatuses serving as the acquisition source of the data is classified, and
when the first classification condition designated by the first operation is to distinguish by each injection molding apparatus serving as the acquisition source, the information processing device displays, on the display unit, the graph in which a figure of a display mode indicating the data amount of each of the plurality of types of first post-classification data obtained as a result of classifying the data by each injection molding apparatus serving as the acquisition source is displayed in association with a numerical value indicating a date.

14. The molding management system according to claim 13, wherein
the graph is a calendar heat map.

15. The molding management system according to claim 1, wherein
when receiving an operation of selecting a region corresponding to at least a part of the plurality of types of first post-classification data displayed in the graph, the information processing device displays, on the display unit, an image for receiving at least one of search and deletion of the data corresponding to the region.

16. The molding management system according to claim 1, further comprising
the terminal device.

17. The molding management system according to claim 1, further comprising
the injection molding apparatus.
